(19) United States
(12) Patent Application Publication
(10) Pub. No.: US 2009/0179891 A1
(43) Pub. Date: Jul. 16, 2009

(54) Scan driver, flat panel display using the same and associated methods

(76) Inventor: Hyun-Soo Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/320,044

(22) Filed: Jan. 15, 2009

(30) Foreign Application Priority Data
Jan. 15, 2008 (KR) 10-2008-0004473

(51) Int. Cl. G09G 5/00; G09G 3/20

(52) U.S. Cl. 345/214; 345/55

(57) ABSTRACT

A scan driver may include a plurality of sub-scan drivers. Each of the sub-scan drivers may include a shift register configured to receive a start pulse and a clock signal to output p shift signals, a selector configured to receive a select control signal and at least two shift signals among the p shift signals of the shift register, and to output one of the at least two shift signals to a next sub-scan driver in accordance with the select control signal, and a buffer configured to receive the p shift signals output from the shift register and to output the p shift signals. A next sub-scan driver may receive the selected shift signal as the start pulse.

### BACKGROUND

1. Field of the Invention

Embodiments relate to a scan driver, a flat panel display using the same, and associated methods. More particularly, embodiments relate to a scan driver in which the number of outputs varies such that the scan driver can be applied to displays having various sizes, a flat panel display using the same, and associated methods.

2. Description of the Related Art

Recently, various types of flat panel displays have been developed having reduced weight and volume. Such flat panel displays include a liquid crystal display, a field emission display, a plasma display panel, and an organic light emitting display. The plasma display panel, which displays an image using plasma generated by gas discharge, is particularly suitable for a large-sized display device.

The flat panel display displays an image in accordance with a data signal transmitted to pixels activated by scanning lines. The more scanning lines provided, the higher the resolution of an image may be realized. Flat panel displays may be classified according the their resolution as standard definition (SD), high definition (HD), and full HD (FHD) in accordance with the number of scanning lines, e.g., 480, 768, and 1080, respectively.

In the flat panel display, a scan signal is transmitted through a plurality of scan drivers. The number of scan drivers typically employed in SD, HD, and FHD flat panel displays is listed in the following Table 1.

TABLE 1

| | Number of scan drivers when | | Number of scan drivers | |
|---|---|---|---|---|
| Resolution | using 64-channel scan | | when using 96-channel | |
| (Number of | drivers (Number of surplus | | scan drivers (Number | |
| scanning lines) | channels) | | of surplus channels) | |
| SD (480) | 8 | (32 channels) | 5 | (0) |
| HD (768) | 12 | (0) | 8 | (0) |
| FHD (1080) | 17 | (72 channels) | 12 | (72 channels) |

When using a scan driver with 64 channels, the SD flat panel display or the FHD flat panel display has surplus channels, since the number of scanning lines is not an integer multiple of the number of channels, here 64. Moreover, when using a scan driver with 96 channels, the FHD flat panel display has surplus channels, since the number of scanning lines is not an integer multiple of the number of channels, here 96.

Therefore, the HD flat panel display and the FHD flat panel display are required to use scan drivers with different numbers of channels to avoid surplus channels, which increase the driving time. Thus, different scan drivers are required to be separately manufactured depending on the type of flat panel display, increasing manufacturing costs of flat panel displays. Further, when different types of scan drivers are used for the different types of flat panel displays, market demand for the different types of flat panel displays must be accurately predicted to reduce or prevent overstocks or shortages from occurring.

### SUMMARY OF THE INVENTION

Embodiments are therefore directed to a scan driver, a flat panel display using the same, and associated methods, which substantially overcome one or more of the disadvantages of the related art.

It is therefore a feature of an embodiment to provide a scan driver in which the number of channels through which a scanning signal is output may be controlled so that the same scan driver may be applied to flat panel displays having various resolutions, a flat panel display using the same, and associated methods.

At least one of the above and other advantages may be realized by providing a scan driver having a plurality of sub-scan drivers, each sub-scan driver including a shift register configured to receive a start pulse and a clock signal to output p shift signals, a selector configured to receive a select control signal and at least two shift signals among the p shift signals of the shift register, and to output one of the at least two shift signals to a next sub-scan driver in accordance with the select control signal, and a buffer configured to receive the p shift signals output from the shift register and to output the p shift signals.

Each sub-scan driver may include a latch configured to receive the shift signal to be transmitted to the buffer and an enable signal. The next sub-scan driver may be configured to receive the shift signal transmitted from the selector as the start pulse. The selector may be configured to output the shift signal before all p shift signals have been output. When the scan driver having k sub-scan drivers is to be used with display having n scanning lines, the selector may be configured to output a q^{th} shift signal, where q=int(n/k).

At least one of the above and other advantages may be realized by providing a flat panel display including a pixel unit displaying an image in response to a data signal and a scan signal, a scan driver transmitting a scan signal to the pixel unit, and a controller outputting a select control signal, the scan driver having a plurality of sub-scan drivers. Each sub-scan driver may include a shift register configured to receive a start pulse and a clock signal to output p shift signals, a selector configured to receive a select control signal and at least two shift signals among the p shift signals of the shift register, and to output one of the at least two shift signals to a next sub-scan driver in accordance with the select control signal, and a buffer configured to receive the p shift signals output from the shift register and to output the p shift signals.

The pixel unit may include a plurality of first electrodes and a plurality of second electrodes, a plurality of third electrodes formed in a direction crossing the first electrodes and the second electrodes, and a plurality of cells formed by the first electrodes, the second electrodes, and the third electrodes. The scan signal may be transmitted through the first electrodes. The pixel unit may include a plasma display panel.

Each sub-scan driver may include a latch configured to receive the shift signal to be transmitted to the buffer and an enable signal. The next sub-scan driver may be configured to receive the shift signal transmitted from the selector as the start pulse. The selector may be configured to output the shift signal before all p shift signals have been output. When the pixel unit includes n scanning lines and the scan driver has k sub-scan drivers, the selector may be configured to output a q^{th} shift signal, where q=int(n/k).

At least one of the above and other advantages may be realized by providing a method of providing scan signals to n scanning lines using k sub-scan drivers, each sub-scan driver having p channels, the method including generating p shift signals in response to a start pulse and a clock signal in a current sub-scan driver, selecting a shift signal from among the p shift signals in accordance with a select control signal, transmitting the selected shift signal to a next sub-scan driver, and outputting the p shift signals from a buffer in the current sub-scan driver.

The method may include generating p shift signals in response to the selected shift signal and a clock signal in the next sub-scan driver. Transmitting the selected shift signal may occur before all p shift signals have been output by the buffer. Selecting may include selecting a q^{th} shift signal, where q=int(n/k).

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a schematic view of a flat panel display according to an embodiment of the present invention;

FIG. 2 illustrates a schematic view of the scan driver in FIG. 1 according to an embodiment; and

FIG. 3 illustrates a block diagram of a driving unit of a plasma display panel as an example of a flat panel display in FIG. 1.

### DETAILED DESCRIPTION OF THE INVENTION

Korean Patent Application No. 10-2008-0004473, filed on Jan. 15, 2008, in the Korean Intellectual Property Office and entitled: “Scan Driver and Flat Panel Display Using the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

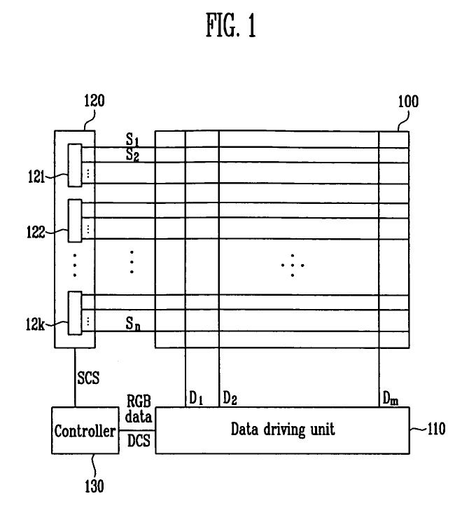

FIG. 1 illustrates a schematic view of a flat panel display according to an embodiment of the present invention. Referring to FIG. 1, the flat panel display may include a pixel unit 100, a data driving unit 110, a scan driver 120, and a controller 130.

The pixel unit 100 may include n scanning lines S1, S2, . . . , and Sn for transmitting scan signals and m data lines D1, D2, . . . , and Dm for transmitting data signals. Pixels may be formed in regions defined by the scanning lines and the data lines.

The data driving unit 110 may generate a data signal in response to a video data having, e.g., red, blue, and green components (RGB data). The data driving unit 110 may be coupled with the data lines D1, D2, . . . , and Dm of the pixel unit 100 to apply data signals to the pixel unit 100.

The scan driver 120 may be coupled with the scanning lines S1, S2, . . . , Sn to transmit the scan signals to the pixel unit 100. When the scan signals are transmitted to the pixels, the data signals output from the data driving unit 110 may be transmitted. The scan driver 120 may include a plurality of sub-scan drivers 121, 122, . . . , and 12k. The number of the sub-scan drivers may vary according to the resolution of the pixel unit 100.

The controller 130 may transmit the video data (RGB data) and a data control signal (DCS) to the data driving unit 110 and may transmit a scan control signal (SCS) to the scan driver 120. Particularly, the controller 130 may output the scan control signal (SCS) to include a select control signal for selecting one of shift signals output from the respective sub-scan drivers 121, 122, . . . , and 12k. Accordingly, one of the sub-scan drivers 121, 122, . . . , and 12k selects one of the shift signals to be transmitted to a next sub-scan driver.

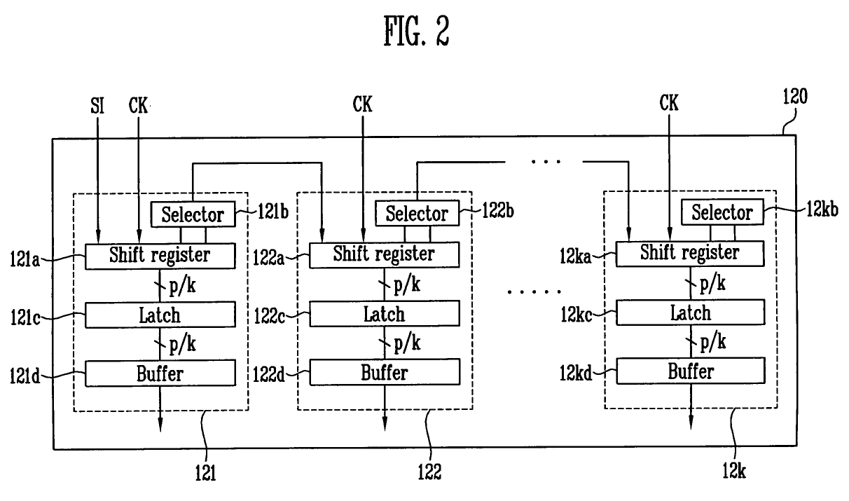

FIG. 2 illustrates a schematic view of the scan driver 120 in FIG. 1 according to an embodiment. Referring to FIG. 2, the scan driver 120 may include the plurality of the sub-scan drivers 121, 122, . . . , and 12k. The sub-scan drivers 121, 122, . . . , and 12k may include shift registers 121a, 122a, . . . , and 12ka, selectors 121b, 122b, . . . , and 12kb, latches 121c, 122c, . . . , and 12kc, and buffers 121d, 122d, . . . , and 12kd, respectively.

The shift registers 121a, 122a, . . . , and 12ka may receive start pulses (SI) and clock signals (CK) to generate p shift signals, i.e., one for each channel. The shift signals may be sequentially generated and transmitted to the latches 121c, 122c, . . . , and 12kc.

The selectors 121b, 122b, . . . , and 12kb may receive a select control signal and optional two shift signals of the p shift signals. The selectors 121b, 122b, . . . , and 12kb may select one of the two shift signals and transmit the selected shift signal to a next sub-scan driver in response to the select control signal.

The latches 121c, 122c, . . . , and 12kc may receive the shift signals and enable signals output from the shift registers 121a, 122a, . . . , and 12ka. Operation of the latches 121c, 122c, . . . , and 12kc may be determined by the enable signals.

The buffers 121d, 122d, . . . , and 12kd may allow signals output from the latches 121c, 122c, . . . , and 12kc to be stably transmitted to the scanning lines. Terminals through which signals are output from the buffers 121d, 122d, . . . , and 12kd are referred to as channels. The number of channels p may be changed according to the sizes of the sub-scan drivers 121, 122, . . . , and 12k.

If the sub-scan drivers 121, 122, . . . , and 12k have 96 channels and are used in a FHD flat panel display, the FHD flat panel display needs 12 sub-scan drivers and has 72 remaining channels in excess of the 1080 scanning lines of the FHD flat panel display. If a 96^{th} shift signal is selected by the selectors 121b, 122b, . . . , and 12kb and input to a next sub-scan driver as start pulses, 72 channels which are not coupled with the scanning lines, e.g., in the foremost sub-scan driver or the latest sub-scan driver of the 12 sub-scan drivers, are present. Since it takes time for the 72 channels of the sub-scan drivers, which are not coupled with scanning lines, to operate when an image is displayed, unnecessary time is required for display.

In contrast, if a 90^{th} shift signal is selected by the selectors 121b, 122b, and 12kb, the 12 sub-scan drivers are coupled with the 90 scanning lines respectively and the last 6 channels of the respective sub-scan drivers are not coupled with scanning lines. Since the 90^{th} shift signal is input to the next sub-scan drivers as start pulses, the next sub-scan drivers operate while the last 6 channels of the respective sub-scan drivers operate, so that the unnecessary time is not spent.

Moreover, if the sub-scan drivers 121, 122, . . . , and 12k with 96 channels are applied to an HD flat panel display with 768 scanning lines, the respective sub-scan drivers 121, 122, . . . , and 12k should use all 96 channels. Therefore, the selectors 121b, 122b, . . . , and 12kb select shift signals output from a 96th channel to transmit them to a next sub-scan driver.

Accordingly, the same scan driver may be applied to any type of flat panel display, i.e., different scan drivers are not required for realizing images of different resolutions. In other words, by controlling which shift signal is output from a current sub-scan driver to a next sub-scan driver, the same scan driver may be used for various displays, reducing manufacturing cost and inventory issues, while reducing or eliminating unnecessary display time due to the presence of excess channels.

In particular, by controlling the shift signal output by the sub-scan drivers, effectively utilizing fewer channels in each sub-scan driver, e.g., only those channels needed for the scanning lines, the same scan driver may be adapted to different display types without increasing display time. So for n scanning lines and k sub-scan drivers, an q^{th} scan signal may be determined as q=int(n/k). Thus, for the particular example above, q=int(1080/12)=90. When the number of scanning lines is not an integer number of sub-scan drivers, there may still be some excess channels, which may result in displaying time longer than needed, but less than using the shift signal from the last channel to initiate a next sub-scan driver.

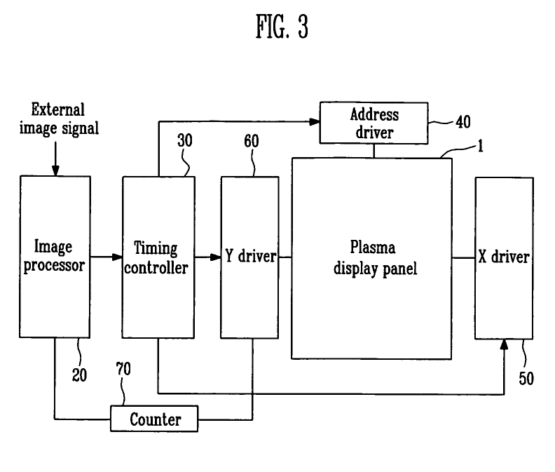

FIG. 3 illustrates a block diagram of a driving unit of a plasma display panel 1 as an example of a flat panel display in FIG. 1. Referring to FIG. 3, the driving unit of the plasma display panel 1 may include an image processor 20, a timing controller 30, an address driver 40, an X-driver 50, a Y-driver 60, and a counter 70.

The image processor 20 may convert an external analog image signal into a digital signal to generate an internal image signal, e.g., 8-bit red, green, and blue digital signals, and may generate a clock signal, a horizontal synchronizing signal, and a vertical synchronizing signal.

The timing controller 30 may generate a driving control signal according to the internal image signal supplied from the image processor 20 and may transmit the driving control signal to the drivers, e.g., the address driver 40, the X-driver 50, and the Y-driver 60. The timing controller 30 may transmit the select control signal to the X-driver 50 such that the X-driver 50 may be used regardless of resolution.

The address driver 40 may process an address signal of the driving control signals supplied from the timing controller 30 to generate a display data signal and may apply the generated display data to address electrode lines. The address driver 40 may perform the same operation as the data driving unit 110 in FIG. 1.

The X-driver 50 may process an X-driving control signal of the driving control signals supplied from the timing controller 30 and may apply the processed X-driving control signal to X-electrode lines.

The Y-driver 60 may process a Y-signal of the driving control signals supplied from the timing controller 30 and may apply the processed Y-signal to Y-electrode lines. The Y-driver 60 may perform the same operation as the scan driver 120 in FIG. 1.

The counter 70 may count a vertical synchronizing signal generated in the image processor 20 and may check a time of using the plasma display panel on the basis of the counted number. The counter 70 may transmit a predetermined signal to the Y-driver 60 after a predetermined time lapses based on the checked using time to adjust a waveform of a driving signal output from the Y-driver 60.

According to the scan driver of an embodiment and the flat panel display using the same, scan signals output from a single scan driver may be adjusted to be applied to flat panel displays in various types. Thus, scan drivers do not need to be made for specific types of flat panel displays.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A scan driver having a plurality of sub-scan drivers, each sub-scan driver comprising:
a shift register configured to receive a start pulse and a clock signal to output p shift signals;
a selector configured to receive a select control signal and at least two shift signals among the p shift signals of the shift register, and to output one of the at least two shift signals to a next sub-scan driver in accordance with the select control signal; and
a buffer configured to receive the p shift signals output from the shift register and to output the p shift signals.

2. The scan driver as claimed in claim 1, wherein each sub-scan driver further comprises a latch configured to receive the shift signal to be transmitted to the buffer and an enable signal.

3. The scan driver as claimed in claim 1, wherein the next sub-scan driver is configured to receive the shift signal transmitted from the selector as the start pulse.

4. The scan driver as claimed in claim 1, wherein the selector is configured to output the shift signal before all p shift signals have been output.

5. The scan driver as claimed in claim 1, wherein, when the scan driver having k sub-scan drivers is to be used with display having n scanning lines, the selector is configured to output a q^{th} shift signal, where q=int(n/k).

6. A flat panel display comprising:
a pixel unit displaying an image in response to a data signal and a scan signal;
a scan driver transmitting a scan signal to the pixel unit; and
a controller outputting a select control signal,
the scan driver having a plurality of sub-scan drivers, each sub-scan driver including:
a shift register configured to receive a start pulse and a clock signal to output p shift signals;
a selector configured to receive a select control signal and at least two shift signals among the p shift signals of the shift register, and to output one of the at least two shift signals to a next sub-scan driver in accordance with the select control signal; and
a buffer configured to receive the p shift signals output from the shift register and to output the p shift signals.

7. The flat panel display as claimed in claim 6, wherein each sub-scan driver further comprises a latch configured to receive the shift signal to be transmitted to the buffer and an enable signal.

8. The flat panel display as claimed in claim 6, wherein the pixel unit comprises:
a plurality of first electrodes and a plurality of second electrodes;
a plurality of third electrodes formed in a direction crossing the first electrodes and the second electrodes; and
a plurality of cells formed by the first electrodes, the second electrodes, and the third electrodes.

9. The flat panel display as claimed in claim 8, wherein the scan signal is transmitted through the first electrodes.

10. The flat panel display as claimed in claim 6, wherein the pixel unit includes a plasma display panel.

11. The flat panel display as claimed in claim 6, wherein the next sub-scan driver is configured to receive the shift signal transmitted from the selector as the start pulse.

12. The flat panel display as claimed in claim 6, wherein the selector is configured to output the shift signal before all p shift signals have been output.

13. The flat panel display as claimed in claim 6, wherein, when the pixel unit includes n scanning lines and the scan driver has k sub-scan drivers, the selector is configured to output a q^{th} shift signal, where q=int(n/k).

14. A method of providing scan signals to n scanning lines using k sub-scan drivers, each sub-scan driver having p channels, the method comprising:
generating p shift signals in response to a start pulse and a clock signal in a current sub-scan driver;
selecting a shift signal from among the p shift signals in accordance with a select control signal;
transmitting the selected shift signal to a next sub-scan driver; and
outputting the p shift signals from a buffer in the current sub-scan driver.

15. The method as claimed in claim 14, further comprising generating p shift signals in response to the selected shift signal and a clock signal in the next sub-scan driver.

16. The method as claimed in claim 14, wherein transmitting the selected shift signal occurs before all p shift signals have been output by the buffer.

17. The method as claimed in claim 14, wherein selecting includes selecting a q^{th} shift signal, where q=int(n/k).

18. The method as claimed in claim 14, wherein the scanning lines are in a flat panel display.

19. The method as claimed in claim 14, wherein the flat panel display includes a plasma display panel.
